(19) United States
(12) Patent Application Publication
(10) Pub. No.: US 2023/0144053 A1
(43) Pub. Date: May 11, 2023

(54) MEDIA STACK HEIGHT ESTIMATION IN IMAGE FORMING APPARATUSES

(71) Applicant: Hewlett- Packard Development Company, L.P., Spring, TX (US)

(72) Inventors: Wei Lit Teoh, Singapore (SG); Seng San Koh, Singapore (SG); Wee Hien Tok, Singapore (SG)

(21) Appl. No.: 17/916,625

(22) PCT Filed: Apr. 15, 2020
(86) PCT No.: PCT/US2020/028170

§ 371 Date: Oct. 3, 2022

(51) Int. Cl. B65H 7/04; G01B 21/08

(52) U.S. Cl. CPC B65H 7/04; G01B 21/08; B65H 2553/51; B65H 3/0684

(57) ABSTRACT

In an example, a method may include determining a range of motion of a pick arm during lifting of the pick arm from a media stack position to a hard stop position in an image forming apparatus. The pick arm may have a pick roller at one end for picking a media sheet from a media stack and pivotally mounted at an opposite end to enable angular movement of the pick arm relative to the media stack. Further, the method may include estimating a height of the media stack based on the determined range of motion of the pick arm from the media stack position to the hard stop position. Furthermore, the method may include indicating an amount of media sheets remaining in the media stack corresponding to the estimated height.

### BACKGROUND

Image forming apparatuses, such as printers, photocopiers and facsimile machines, and the like, may include a media stack tray to store and dispense media (e.g., papers) from a media stack to a printing head of an image forming apparatus. The dispensing of the media may be performed using a dispensing device, such as a pick arm mechanism, which selects and dispenses the media from the media stack tray.

### BRIEF DESCRIPTION OF THE DRAWINGS

Examples are described in the following detailed description and in reference to the drawings, in which:

FIG. 1A is a schematic cross-sectional side view of an example image forming apparatus, depicting a pick arm in a media stack position;

FIG. 1B is a schematic cross-sectional side view of the example image forming apparatus of FIG. 1A, depicting the pick arm in a hard stop position;

FIG. 2A is a schematic cross-sectional side view of an example image forming apparatus, depicting an encoder wheel to generate encoder counts, which can be utilized to determine a range of motion of a pick arm;

FIG. 2B is a schematic cross-sectional side view of an example image forming apparatus, depicting a counter to count a time elapsed or a number of pulses applied to an electric motor;

FIG. 3 illustrates an example method for indicating an amount of media sheets remaining in a media stack based on a range of motion of a pick arm;

FIG. 4 is a block diagram of an example image forming apparatus including a non-transitory machine-readable storage medium, storing instructions to indicate an amount of media sheets remaining in a media stack;

FIG. 5 is a flow diagram illustrating an example method for de-binding and zeroing a position of a pick arm; and

FIGS. 6A-6D illustrate schematic cross-sectional side views of an example image forming apparatus, depicting an example movement of a pick arm during de-binding of the pick arm.

### DETAILED DESCRIPTION

Image forming apparatuses, such as inkjet printers, that feed media from a media stack may be deficient in providing a warning of an impending depleted media stack condition. For example, consider that a print job may be issued to the image forming apparatus and the media stack may be depleted during the print job. In this case, a user may have to reload the media stack to resume the print job, which may cause a delay in completing the print job. With the proliferation of network image forming apparatuses, the ability to make a visual assessment of a media stack level may be reduced, and the delays caused by unexpected media stack depletions may be frequent and significantly longer in duration.

Some example height sensing mechanisms may employ a pivotally mounted pick arm that may be in contact with a top of the media stack. Such height sensing mechanisms may sense an angular displacement of the pick arm as the media stack height changes to provide an indication of a sheet quantity remaining in the media stack. However, such mechanisms may generate some form of an electrical signal which changes in proportion to the change in the height of the media stack as represented by the change in the angular position of the pick arm.

Some other example methods may utilize a proximity sensor, mounted at a back of a pressure plate, to detect a change of distance/angle between the pressure plate and the media stack loaded into the media stack tray. The different levels of the media stack may vary an amount of signal that may be reflected to the proximity sensor. Further, the image forming apparatus may be able to indicate an amount of media in the media stack tray using such variation. However, such example methods may involve additional cost of the proximity sensors and may be suited for systems that can provide a consistent reflective surface for the sensor to minimize noise.

Examples described herein may provide an image forming apparatus having a controller to determine a range of motion of a pick arm during lifting of the pick arm from a media stack position to a hard stop position. The pick arm may have a pick roller at one end for picking a media sheet from a media stack and pivotally mounted at an opposite end to enable angular movement of the pick arm relative to the media stack. Further, the controller may estimate a height of the media stack based on the determined range of motion of the pick arm from the media stack position to the hard stop position. Furthermore, the controller may indicate an amount of media sheets remaining in the media stack corresponding to the estimated height.

Thus, examples described herein may determine the height of the media stack by:
making the pick arm to contact a surface of the media stack,
considering an amount of rotation of the pick arm from the surface to the hard stop position (i.e., fully up position), and
referencing a value corresponding to the amount of rotation to a value corresponding to a rotation of the pick arm from a calibrated empty media stack or a fully loaded media stack to the hard stop position.

Examples described herein may consider a behaviour of the pick arm that provides a downward force during picking for media stack height sensing, which can address an inaccurate sensing due to air gap between sheets of media. For example, a compression spring loaded on the pick arm and a weight of the pick arm may minimize the inaccurate media stack height sensing due to the air gap between the sheets of media. Further, examples described herein may utilize an encoder-based media stack height sensing, which may involve significantly less cost compared to media stack height sensing mechanisms that use sensors, In addition, the media stack height sensing described herein may be less sensitive to media type being sensed compared to the proximity sensing that may be sensitive to the media surface reflectance.

In another example, the controller may perform zeroing of a position of the pick arm prior to determining the range of motion of the pick arm. In this example, zeroing the position of the pick arm may be performed to compensate for a backlash in a gear mechanism coupled to the pick arm. Further, by zeroing the position of the pick arm, examples described herein may not have to resort to the use of low cogging torque motors for media stack height sensing applications. Also, zeroing the position of the pick arm may enhance the media stack height sensing by countering mechanical variations (e.g., stickiness, cogging, and the like) associated with the pick arm movement.

In the following description, for purposes of explanation, numerous specific details are set forth in order to provide a thorough understanding of the present techniques. However, the example apparatuses, devices and systems, may be practiced without these specific details. Reference in the specification to “an example” or similar language means that a feature, structure, or characteristic described is included in at least that one example but may not be in other examples.

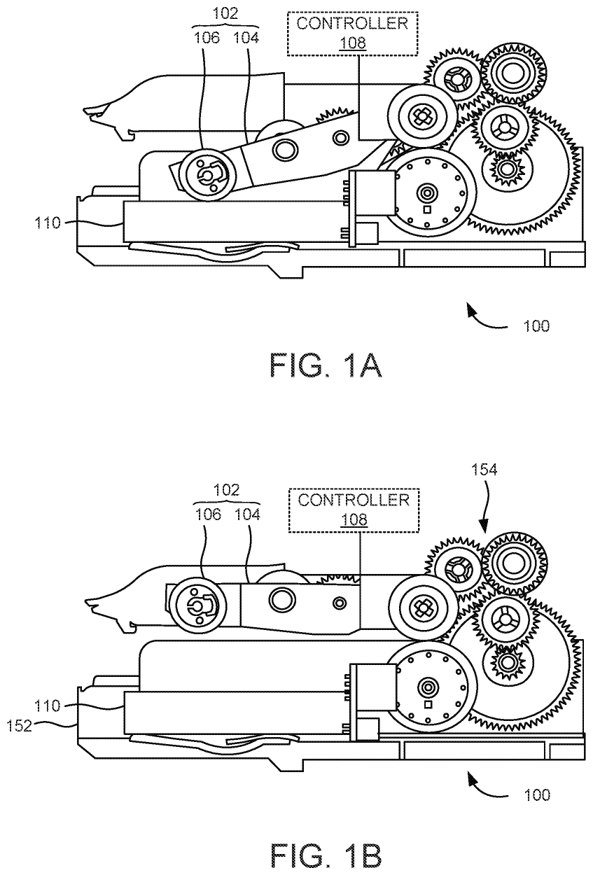

Turning now to the figures, FIG. 1A is a schematic cross-sectional side view of an example image forming apparatus 100, depicting a pick arm 104 in a media stack position. FIG. 1B is a schematic cross-sectional side view of example image forming apparatus 100 of FIG. 1A, depicting pick arm 104 in a hard stop position. For example, similarly named elements of FIG. 1A may be similar in structure and/or function to elements described with respect to FIG. 1B, Image forming apparatus 100 may generate a physical representation of print content received from a client device (e.g., a personal computer, a desktop computer, a mobile device, or the like). For example, the client device may be connected to image forming apparatus 100 through a wired or a wireless network, such as a local area network (LAN) or a wide area network (WAN). The client device may include a processor and memory coupled to the processor. The memory may include a printer agent such as a printer driver that may be either installed in or accessible to the client device to access image forming apparatus 100.

In one example, image forming apparatus 100 may be a single-function device such as a printer, copier, fax, or the like. In another example, image forming apparatus 100 may be a multifunction printing device. In this example, the multifunction printing device may be implemented as a commercially available printer including the functionalities of a printer along with a scanner, a copier, a fax, and/or the like. Example multifunction printing device may be a printer-copier, a printer-scanner-copier-fax, or the like. The terms “image forming apparatus”, “printer”, and “multifunction printing device” may be used interchangeably throughout the document.

As shown in FIGS. 1A and 1B, example image forming apparatus 100 may include a pick arm assembly 102. Further, pick arm assembly 102 may include pick arm 104 and a pick roller 106 mounted to one end of pick arm 104 to pick a media sheet from a media stack 110. Further, pick arm 104 may be pivotally mounted at an opposite end to enable an angular position change of pick arm 104 relative to media stack 110. As shown in FIG. 1B, image forming apparatus 100 may include a tray 152 to hold media stack 110.

Further, image forming apparatus 100 may include a controller 108 operatively coupled to pick arm assembly 102. In one example, controller 108 may be implemented as an engine or module including any combination of hardware and programming to implement the functionalities described herein.

During operation, controller 108 may determine a range of motion of pick arm 104 during lifting of pick arm 104 from the media stack position (e.g., as shown in FIG. 1A) to the hard stop position (e.g., as shown in FIG. 1B). The term “media stack position” may refer to a position of pick arm 104 in which pick roller 106 may physically contact a top surface of media stack 110. Further, the term “hard stop position” may refer to a position that limits the range of movement of pick arm 104 in a direction away from media stack 110.

In some examples, controller 108 may perform zeroing of a position of pick arm 104 prior to determining the range of motion of pick arm 104. For example, controller 108 may perform the zeroing of the position of pick arm 104 to compensate for a backlash in a gear mechanism coupled to pick arm 104.

As shown in FIG. 1B, image forming apparatus 100 may include a gear mechanism or gear train 154. Example gear mechanism 154 may be controlled by controller 108. Further, image forming apparatus 100 may include a motor to drive gear mechanism 154. During operation, gear mechanism 154 may transmit power from the motor to lift pick arm 104.

However, gear mechanism 154 may include a rotational backlash. The backlash may have to be zero-ed out, prior to lifting pick arm 104 to determine the range of motion. Since there may be no real ‘hard’ home at the start of lifting, controller 108 may check whether there may be a difference between the backlashed motion (i.e., dwell) vs pick lifting load to zero a position of pick arm 104. Thus, controller 108 may determine a torque change between non-lifting (i.e., dwell) and lifting of pick arm 104. When the motion reaches a delta-torque threshold, controller 108 may set a current position of pick arm 104 to indicate point of starting to engage a weight of pick arm 104. Furthermore, controller 108 may stop the motion of pick arm 104 and set the current position as ‘zero’ prior to determining the range of motion of pick arm 104.

Further, controller 108 may estimate a height of media stack 110 based on the determined range of motion from the media stack position to the hard stop position. In one example, controller 108 may estimate the height of media stack 110 by applying an interpolation based on the determined range of motion and a reference range of motion of pick arm 104. In this example, the reference range of motion may correspond to the motion of pick arm 104 from a calibrated empty media stack value or a fully loaded media stack value to the hard stop position. Example interpolation may include a linear interpolation, a piecewise linear interpolation, a quadratic interpolation, or the like.

In another example, controller 108 may estimate the height of media stack 110 corresponding to the determined range of motion using a look-up table. In this example, the look-up table may include a plurality of ranges of motion mapped to a corresponding one of a plurality of heights of the media stack.

Furthermore, controller 108 may indicate an amount of media sheets remaining in media stack 110 corresponding to the estimated height. In one example, the amount of media sheets remaining in media stack 110 may be indicated on image forming apparatus 100. In another example, the amount of media sheets remaining in media stack 110 may be indicated on the client device that may be connected to image forming apparatus 100 through the wired or wireless network.

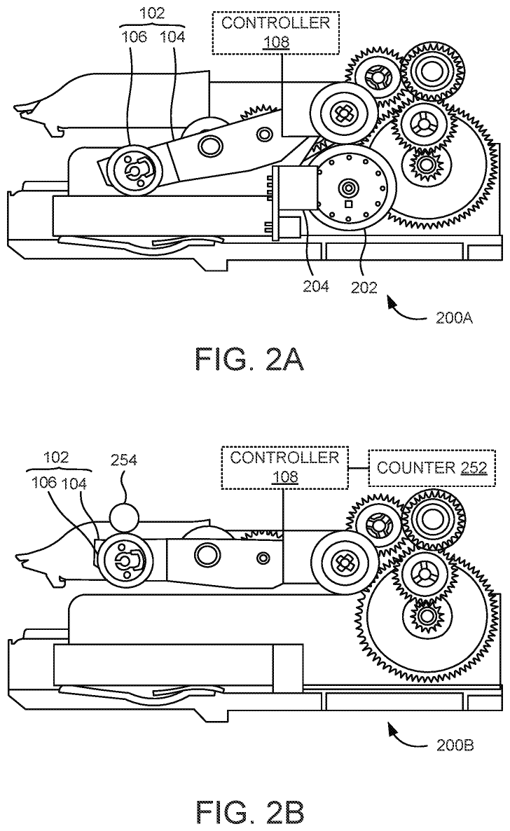

FIG. 2A is a schematic cross-sectional side view of an example image forming apparatus 200A (e.g., image forming apparatus 100 of FIG. 1A), depicting an encoder wheel 202 to generate encoder counts, which can be utilized to determine the range of motion of pick arm 104. For example, similarly named elements of FIG. 2A may be similar in structure and/or function to elements described with respect to FIG. 1A. As shown in FIG. 2A, image forming apparatus 200A may include encoder wheel 202. In one example, encoder wheel 202 may be disposed in image forming apparatus 200A such that encoder wheel 202 may rotate with pick arm 104. For example, encoder wheel 202 may be mounted on pick arm 104 to undergo rotational movement with pick arm 104. In other examples, encoder wheel 202 can be mounted to an idle gear, a lifting motor, a pick arm shaft, or any position along a transmission path such that encoder wheel 202 can rotate with pick arm 104.

For example, encoder-based media stack height sensing (i.e., using encoder wheel 202) can be used in image forming apparatuses that utilize closed loop control motors as actuators to life pick arm 104. Example closed loop control motors may include servomotors (e.g., DC servomotors). Closed loop control motors, for instance, may detect a physical motion limit (e.g., the hard stop position) of pick arm 104 during the lifting of pick arm 104 from the media stack position by stalling the closed loop control motors. The term “stalling” may refer to a condition at which the closed loop control motor stops rotating even when there is voltage at terminals. This condition may occur when the torque associated with the load may be more than the maximum torque (i.e., breakdown torque) that can be generated by the closed loop control motor. Thus, the hard stop position of pick arm 104 may be detected without the use of limit switches.

Further, encoder wheel 202 may have a pattern of markings thereon. During operation, encoder wheel 202 may detect the hard stop position of pick arm 104 during the lifting of pick arm 104 from the media stack position and generate the encoder counts. Furthermore, controller 108 may determine the range of motion of pick arm 104 from the media stack position to the detected hard stop position using the encoder counts. In this example, controller 108 may receive the encoder counts via a sensor/serial interface circuit 204 disposed in communication with encoder wheel 202.

FIG. 2B is a schematic cross-sectional side view of an example image forming apparatus 200B (e.g., image forming apparatus 100 of FIG. 1A), depicting a counter 252 to count a time elapsed or a number of pulses applied to an electric motor. For example, similarly named elements of FIG. 2B may be similar in structure and/or function to elements described with respect to FIG. 1A. As shown in FIG. 2B, image forming apparatus 200B may include a limit switch 254 and counter 252.

For example, pulse count or time count-based media stack height sensing (e.g., using limit switch 254 and counter 252) can be used in image forming apparatuses that utilize open loop control motors as actuators to lift pick arm 104. Example open loop control motors may include stepper motors, brushless DC-motors, or the like. Further, limit switch 254 may be disposed in image forming apparatus 200B such that limit switch 254 can detect the hard stop position of pick arm 104 during angular movement of pick arm 104. Furthermore, limit switch 254 may provide a limit signal when physically contacted by pick arm 104 during the angular movement. Example limit switch 254 may include a limit sensor, a microswitch, a tact switch, or the like.

During the lifting of pick arm 104 from the media stack position, limit switch 254 may limit the movement of pick arm 104 at the hard stop position. Further, counter 252 may count a time elapsed or a number of pulses applied to an electric motor to lift pick arm 104 from the media stack position to the hard stop position. Furthermore, controller 108 may determine the range of motion of pick arm 104 during the lifting of pick arm 104 from the media stack position to the hard stop position using the time elapsed or the number of pulses.

Image forming apparatus 100, 200A, or 200B may include computer-readable storage medium including (e.g., encoded with) instructions executable by a processor to implement functionalities described herein in relation to FIGS. 1A, 1B, 2A, and 2B. In some examples, the functionalities described herein, in relation to instructions to implement functions of components of image forming apparatus 100, 200A, or 200B and any additional instructions described herein in relation to the storage medium, may be implemented as engines or modules including any combination of hardware and programming to implement the functionalities of the modules or engines described herein. The functions of components of image forming apparatus 100, 200A, or 200B may also be implemented by a respective processor. In examples described herein, the processor may include, for example, one processor or multiple processors included in a single device or distributed across multiple devices.

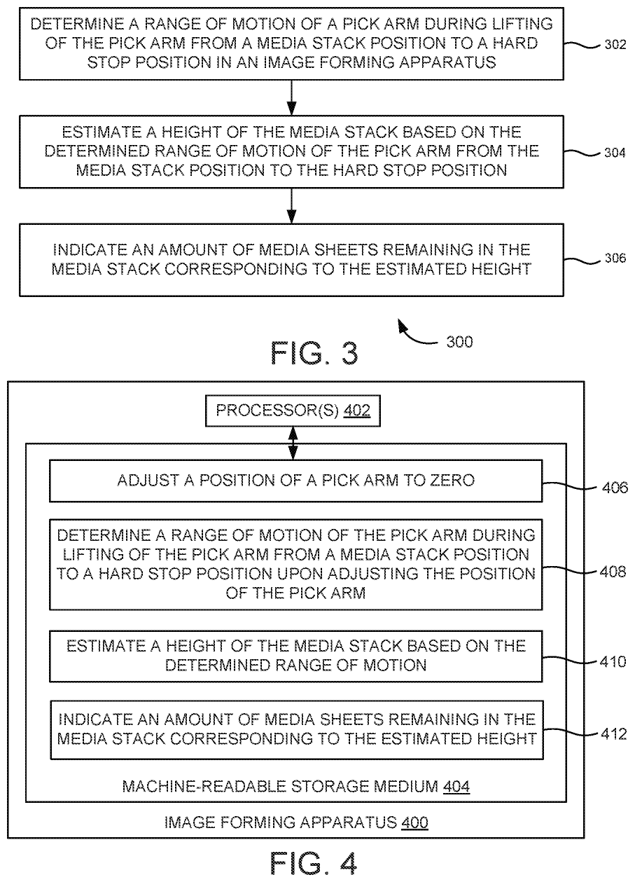

FIG. 3 illustrates an example method 300 for indicating an amount of media sheets remaining in a media stack based on a range of motion of a pick arm. It should be understood that the process depicted in FIG. 3 represents generalized illustrations, and that other processes may be added, or existing processes may be removed, modified, or rearranged without departing from the scope and spirit of the present application. In addition, it should be understood that the processes may represent instructions stored on a computer-readable storage medium that, when executed, may cause a processor to respond, to perform actions, to change states, and/or to make decisions. Alternatively, the processes may represent functions and/or actions performed by functionally equivalent circuits like analog circuits, digital signal processing circuits, application specific integrated circuits (ASICs), or other hardware components associated with the system. Furthermore, example method 300 may not be intended to limit the implementation of the present application, but rather example method 300 illustrates functional information to design/fabricate circuits, generate machine-readable instructions, or use a combination of hardware and machine-readable instructions to perform the illustrated processes.

At 302, the range of motion of the pick arm may be determined during lifting of the pick arm from a media stack position to a hard stop position in an image forming apparatus. Example pick arm may have a pick roller at one end for picking a media sheet from a media stack and pivotally mounted at an opposite end to enable angular movement of the pick arm relative to the media stack.

In one example, determining the range of motion of the pick arm may include:
detecting the hard stop position of the pick arm during the lifting of the pick arm from the media stack position using an encoder wheel that rotates with the pick arm, and
determining the range of motion of the pick arm from the media stack position to the detected hard stop position using encoder counts of the encoder wheel.

In another example, determining the range of motion of the pick arm may include determining the range of motion of the pick arm by counting a number of pulses applied to an electric motor to lift the pick arm from the media stack position to the hard stop position. In this example, the hard stop position may be detected using a limit switch.

In yet another example, determining the range of motion of the pick arm may include determining the range of motion of the pick arm by counting a time elapsed during the lifting of the pick arm from the media stack position to the hard stop position. In this example, the hard stop position may be detected using the limit switch.

At 304, a height of the media stack may be estimated based on the determined range of motion of the pick arm from the media stack position to the hard stop position. In one example, the height of the media stack may be estimated by applying an interpolation based on the determined range of motion and a reference range of motion of the pick arm from a calibrated empty media stack value or a fully loaded media stack value to the hard stop position.

In yet another example, the height of the media stack corresponding to the determined range of motion may be estimated using a look-up table. In this example, the look-up table may include a plurality of ranges of motion mapped to a corresponding one of a plurality of heights of the media stack. At 306, an amount (e.g., quantity, percentage, or the like) of media sheets remaining in the media stack corresponding to the estimated height may be indicated.

FIG. 4 is a block diagram of an example image forming apparatus 400 including a non-transitory machine-readable storage medium 404, storing instructions (e.g., 406 to 412) to indicate an amount of media sheets remaining in a media stack. Image forming apparatus 400 may include a processor 402 and machine-readable storage medium 404 communicatively coupled through a system bus. Processor 402 may be any type of central processing unit (CPU), microprocessor, or processing logic that interprets and executes machine-readable instructions stored in machine-readable storage medium 404. Machine-readable storage medium 404 may be a random-access memory (RAM) or another type of dynamic storage device that may store information and machine-readable instructions that may be executed by processor 402. For example, machine-readable storage medium 404 may be synchronous DRAM (SDRAM), double data rate (DDR), rambus DRAM (RDRAM), rambus RAM, etc., or storage memory media such as a floppy disk, a hard disk, a CD-ROM, a DVD, a pen drive, and the like. In an example, machine-readable storage medium 404 may be a non-transitory machine-readable medium. In an example, machine-readable storage medium 404 may be remote but accessible to image forming apparatus 400.

As shown in FIG. 4, machine-readable storage medium 404 may store instructions 406-412. In an example, instructions 406-412 may be executed by processor 402 to indicate the amount of media sheets remaining in the media stack corresponding to an estimated height of the media stack. Instructions 406 may be executed by processor 402 to adjust a position of the pick arm to zero. In one example, the pick arm may have a pick roller at one end for picking a media sheet from a media stack and pivotally mounted at an opposite end to enable angular movement of the pick arm relative to the media stack.

In some examples, machine-readable storage medium 404 may store instructions to de-bind a lift transmission mechanism and the pick arm to move the pick arm on to the media stack prior to zeroing the position of the pick arm. Further, instructions to adjust the position of the pick arm to zero may include instructions to adjust the position of the pick arm to compensate for a backlash in a gear mechanism coupled to the pick arm.

In some examples, instructions to adjust the position of the pick arm may include instructions to hunt for a torque change during the lifting of the pick arm from the media stack position. The torque change may be triggered upon the lift transmission mechanism engaging a weight of the pick arm, thereby eliminating the backlash of the gear mechanism. Further, instructions to adjust the position of the pick arm may include instructions to set a current position of the pick arm, at which the torque change is triggered, to zero. The current position may indicate a starting point to determine the range of motion.

Instructions 408 may be executed by processor 402 to determine the range of motion of the pick arm during lifting of the pick arm from a media stack position to a hard stop position upon adjusting the position of the pick arm.

In one example, instructions to determine the range of motion of the pick arm may include instructions to detect the hard stop position of the pick arm during the lifting of the pick arm from the media stack position using an encoder wheel that rotates with the pick arm and determine the range of motion of the pick arm during the lifting of the pick arm from the media stack position to the detected hard stop position using encoder counts of the encoder wheel.

In another example, instructions to determine the range of motion of the pick arm may include instructions to determine the range of motion of the pick arm by counting a number of pulses applied to an electric motor to lift the pick arm from the media stack position to the hard stop position. In this example, the hard stop position may be detected using a limit switch.

In yet another example, instructions to determine the range of motion of the pick arm may include instructions to determine the range of motion of the pick arm by counting a time elapsed during the lifting of the pick arm from the media stack position to the hard stop position. In this example, the hard stop position may be detected using the limit switch.

Instructions 410 may be executed by processor 402 to estimate a height of the media stack based on the determined range of motion, for instance, by applying an interpolation or using a look-up table. Instructions 412 may be executed by processor 402 to indicate an amount of media sheets remaining in the media stack corresponding to the estimated height.

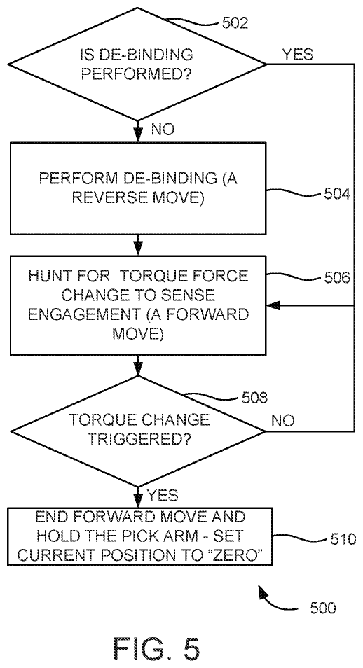

FIG. 5 is a flow diagram 500 illustrating an example method for de-binding and zeroing a pick arm. It should be understood that the process depicted in FIG. 5 represents generalized illustrations, and that other processes may be added, or existing processes may be removed, modified, or rearranged without departing from the scope and spirit of the present application. In addition, it should be understood that the processes may represent instructions stored on a computer-readable storage medium that, when executed, may cause a processor to respond, to perform actions, to change states, and/or to make decisions. Alternatively, the processes may represent functions and/or actions performed by functionally equivalent circuits like analog circuits, digital signal processing circuits, application specific integrated circuits (ASICs), or other hardware components associated with the system. Furthermore, example method 500 may not be intended to limit the implementation of the present application, but rather example method 500 illustrates functional information to design/fabricate circuits, generate machine-readable instructions, or use a combination of hardware and machine-readable instructions to perform the illustrated processes.

In order to sense a height of a media stack, the pick arm may have to be lowered to physically contact a top surface of the media stack. However, the pick arm may not be completely lowered at the start of the media stack height sensing, which can render subsequent media stack height sensing with a false ‘0’ point. In this case, a “sticky” pick arm lift transmission may prevent smooth pick arm drop after motor is de-energized. Therefore, the media stack height sensing may provide false readings due to false ‘0’s. The false ‘0’ point may be caused due to a presence of transmission binding. The transmission binding may cause the motor to lock within a particular rotational phase, due to motor cogging. Therefore, de-binding the lift transmission mechanism and the pick arm to move the pick arm on to the media stack may need to be performed prior to zeroing the position of the pick arm.

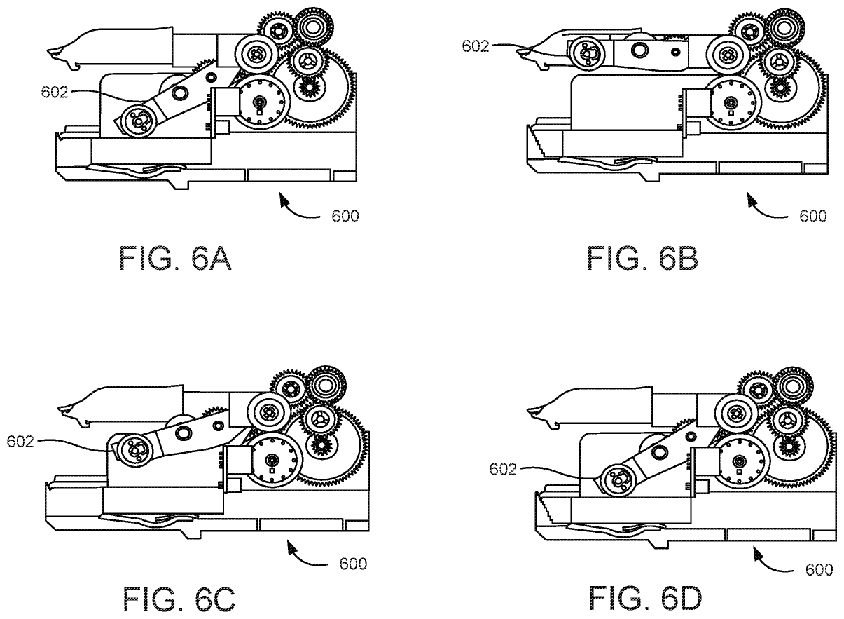

At 502, a check may be made to determine whether the de-binding of the pick arm is performed prior to zeroing a position of the pick arm. When the de-binding of the pick arm is performed, the method may proceed to block 506. When the de-binding of the pick arm is not performed, at 504, the lift transmission mechanism and the pick arm may be de-bound to move the pick arm on to the media stack. In this example, de-binding is performed by moving the motor in an opposite direction (i.e., a reverse move). An example mechanism to de-bind the pick arm is explained with respect to FIGS. 6A-6D,

Upon performing the de-binding, at 506, a torque change during the lifting of the pick arm from the media stack position may be hunted, for instance, by moving the motor in a forward direction (i.e., a forward move). For example, the torque change may be triggered upon the lift transmission mechanism engaging a weight of the pick arm. At 508, a check may be made to determine whether the torque change is triggered. In this example, the motor may be moved in the forward direction until the torque change is triggered.

At 510, the movement of the motor in the forward direction may be stopped and the pick arm may be held in a current position. Further, the current position of the pick arm, at which the torque change is triggered, may be set to zero, The current position may indicate a starting point to determine the range of motion.

FIGS. 6A-6D illustrate schematic cross-sectional side views of an example image forming apparatus 600, depicting an example movement of pick arm 602 during de-binding of pick arm 602. As shown in FIG. 6A, pick arm 602 may be in a first position. As shown in FIG. 6B, pick arm 602 may be lifted from the first position to a hard stop position (i.e., a pick arm stop position). At this position, binding of a lift transmission mechanism may occur. Example Lift transmission mechanism may include a gear mechanism mounted to a support bracket, and a motor mounted to the support bracket to drive the gear mechanism. As shown in FIG. 60, the motor that lifts pick arm 602 may be turned off and hence pick arm 602 may be lowered to a second position. In this case, the distance lowered from the pick arm stop to the second position may be less than the distance lifted from the first position and the pick arm stop as shown in FIG. 6B. This may be because of significant stuckage due to lift transmission binding and/or motor togging.

As shown in FIG. 6D, the motor may be moved in a reverse/opposite direction to perform de-binding as described with respect to FIG. 5. Example pick arm 602 may be lowered from the second position onto the media stack by performing unbinding/de-binding. Then, zeroing may be performed by moving the motor in a forward direction as described with respect to FIG. 5.

The above-described examples are for the purpose of illustration. Although the above examples have been described in conjunction with example implementations thereof, numerous modifications may be possible without materially departing from the teachings of the subject matter described herein. Other substitutions, modifications, and changes may be made without departing from the spirit of the subject matter. Also, the features disclosed in this specification (including any accompanying claims, abstract, and drawings), and/or any method or process so disclosed, may be combined in any combination, except combinations where at least some of such features are mutually exclusive.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus.

The present description has been shown and described with reference to the foregoing examples. It is understood, however, that other forms, details, and examples can be made without departing from the spirit and scope of the present subject matter that is defined in the following claims.

What is claimed is:

1. A method comprising:
determining a range of motion of a pick arm during lifting of the pick arm from a media stack position to a hard stop position in an image forming apparatus, the pick arm having a pick roller at one end for picking a media sheet from a media stack and pivotally mounted at an opposite end to enable angular movement of the pick arm relative to the media stack;
estimating a height of the media stack based on the determined range of motion of the pick arm from the media stack position to the hard stop position; and
indicating an amount of media sheets remaining in the media stack corresponding to the estimated height.

2. The method of claim 1, wherein determining the range of motion of the pick arm comprises:
detecting the hard stop position of the pick arm during the lifting of the pick arm from the media stack position using an encoder wheel that rotates with the pick arm; and
determining the range of motion of the pick arm from the media stack position to the detected hard stop position using encoder counts of the encoder wheel.

3. The method of claim 1 wherein determining the range of motion of the pick arm comprises:
determining the range of motion of the pick arm by counting a number of pulses applied to an electric motor to lift the pick arm from the media stack position to the hard stop position, wherein the hard stop position is detected using a limit switch.

4. The method of claim 1, wherein determining the range of motion of the pick arm comprises:
determining the range of motion of the pick arm by counting a time elapsed during the lifting of the pick arm from the media stack position to the hard stop position, wherein the hard stop position is detected using a limit switch.

5. The method of claim 1, wherein estimating the height of the media stack comprises:
estimating the height of the media stack by applying an interpolation based on the determined range of motion and a reference range of motion of the pick arm from a calibrated empty media stack value or a fully loaded media stack value to the hard stop position.

6. The method of claim 1, wherein estimating the height of the media stack comprises:
estimating the height of the media stack corresponding to the determined range of motion using a look-up table, wherein the look-up table comprises a plurality of ranges of motion mapped to a corresponding one of a plurality of heights of the media stack.

7. An image forming apparatus comprising:
a pick arm assembly having:
a pick arm; and
a pick roller mounted to one end of the pick arm to pick a media sheet from a media stack, wherein the pick arm is pivotally mounted at an opposite end to enable an angular position change of the pick arm relative to the media stack; and
a controller operatively coupled to the pick arm assembly to:
determine a range of motion of the pick arm during lifting of the pick arm from a media stack position to a hard stop position;
estimate a height of the media stack based on the determined range of motion from the media stack position to the hard stop position; and
indicate an amount of media sheets remaining in the media stack corresponding to the estimated height.

8. The image forming apparatus of claim 7, wherein the controller is to perform zeroing of a position of the pick arm prior to determining the range of motion of the pick arm, wherein zeroing the position of the pick arm is performed to compensate for a backlash in a gear mechanism coupled to the pick arm.

9. The image forming apparatus of claim 7, further comprising:
an encoder wheel disposed in the image forming apparatus such that the encoder wheel is to rotate with the pick arm, wherein the encoder wheel having a pattern of markings thereon, wherein the encoder wheel is to detect the hard stop position of the pick arm during the lifting of the pick arm from the media stack position and generate encoder counts, and wherein the controller is to determine the range of motion of the pick arm from the media stack position to the detected hard stop position using the encoder counts.

10. The image forming apparatus of claim 7, further comprising:
a limit switch to limit a movement of the pick arm at the hard stop position during the lifting of the pick arm; and
a counter to count a time elapsed or a number of pulses applied to an electric motor to lift the pick arm from the media stack position to the hard stop position, and wherein the controller is to determine the range of motion of the pick arm during the lifting of the pick arm from the media stack position to the hard stop position using the time elapsed or the number of pulses.

11. A non-transitory machine-readable storage medium encoded with instructions that, when executed by an image forming apparatus, cause the image forming apparatus to:
adjust a position of a pick arm to zero, the pick arm having a pick roller at one end for picking a media sheet from a media stack and pivotally mounted at an opposite end to enable angular movement of the pick arm relative to the media stack;
determine a range of motion of the pick arm during lifting of the pick arm from a media stack position to a hard stop position upon adjusting the position of the pick arm;
estimate a height of the media stack based on the determined range of motion; and
indicate an amount of media sheets remaining in the media stack corresponding to the estimated height.

12. The non-transitory machine-readable storage medium of claim 11, wherein instructions to adjust the position of the pick arm to zero comprise instructions to:
adjust the position of the pick arm to compensate for a backlash in a gear mechanism coupled to the pick arm.

13. The non-transitory machine-readable storage medium of claim 11, wherein instructions to adjust the position of the pick arm comprise instructions to:
hunt for a torque change during the lifting of the pick arm from the media stack position, wherein the torque change is triggered upon a lift transmission mechanism engaging a weight of the pick arm; and
set a current position of the pick arm, at which the torque change is triggered, to zero, wherein the current position is to indicate a starting point to determine the range of motion.

14. The non-transitory machine-readable storage medium of claim 11, further comprising instructions to:
de-bind a lift transmission mechanism and the pick arm to move the pick arm on to the media stack prior to zeroing the position of the pick arm.

15. The non-transitory machine-readable storage medium of claim 11, wherein instructions to determine the range of motion of the pick arm comprise instructions to:
detect the hard stop position of the pick arm during the lifting of the pick arm from the media stack position using an encoder wheel that rotates with the pick arm and determine the range of motion of the pick arm during the lifting of the pick arm from the media stack position to the detected hard stop position using encoder counts of the encoder wheel;
determine the range of motion of the pick arm by counting a number of pulses applied to an electric motor to lift the pick arm from the media stack position to the hard stop position, wherein the hard stop position is detected using a limit switch; or
determine the range of motion of the pick arm by counting a time elapsed during the lifting of the pick arm from the media stack position to the hard stop position, wherein the hard stop position is detected using the limit switch.
